(19) United States
(12) Patent Application Publication
(10) Pub. No.: US 2005/0039553 A1
(43) Pub. Date: Feb. 24, 2005

(54) Linear actuator

(76) Inventors: Yuan Chen, Taichung (TW); Fu-Yan Cheng, Taichung (TW)

Correspondence Address: CHARLES E. BAXLEY, ESQUIRE, Third Floor, 90 John Street, New York, NY, 10038, US

(21) Appl. No.: 10/646,953

(22) Filed: Aug. 22, 2003

(51) Int. Cl. F16H 21/00; F16H 25/08

(52) U.S. Cl. 74/22 R

(57) ABSTRACT

A linear actuator includes a sleeve, a spindle rotatable in both directions, a threaded threaded nut driving a piston rod, and a motor capable of driving the spindle through a transmission, a self-braking unit being arranged in the transmission to stop the actuator whenever the power is been shut off. All axis force will be blocked outside the sleeve, and thus transmission can transmit torque smoothly. Transmission is designed as a coupling that makes good flexibility to assembly. Parts are circular design to make.

### BACKGROUND OF THE INVENTION

1. Field of the Invention

The present invention relates to a linear actuator, and more particularly to an actuator which is applicable to any kind of reciprocating devices, such as the actuator of kitchen ventilator, the adjustable sickbed and that of the elevator and the likes.

2. Description of the Prior Arts

Linear actuator generally comprises a base body, a motor, reduction gears, spindle, threaded nut and output shaft and etc. The function of the actuator is for outputting the rotation of the motor first, and which is then decelerated by reduction gears to a desired speed, the reduced rotation is transmitted to the spindle and the threaded nut serves for turning the rotating force of the spindle into linear driving force, such that drives the output shaft to move back and forth reciprocatedly so as to effect the movement of the workpiece to be operated.

A conventional linear actuator, such as disclosed in DK 155291 and DK 86292, wherein the rotating force of the motor is transmitted to the spindle by virtue of the reduction gears, which is then turned into linear driving force by virtue of the threaded nut whereby to drive the output shaft and make it reciprocate linearly. Due to the design of the conventional base body and the reduction gears, it is not smooth transmission that during torque transmission there are two sharp turns of right angle, the structure of the reduction gears is rather complicated, which accordingly makes the processing as well as assembly of it more complicated and further increases the install space of the same. In addition, the conventional linear actuator is normally integrally formed, which not only makes the maintenance (uneasy for assembling and dismantling) difficult but also it is uneasy to align the central line in assembling, which possibly leads to vibration as well as noise of the actuator in operation and further brings about high rate of bad products as well.

The present invention has arisen to mitigate and/or obviate the afore-described disadvantages of the conventional linear actuator.

### SUMMARY OF THE INVENTION

In accordance with one aspect of the present invention the linear actuator generally comprises a power set, sleeve, transmission means and actuator. Wherein the sleeve has both ends axially for coupling with the power set and the actuator respectively, the power set, the transmission means and the actuator are coupled with each other in the sleeve in a coaxial manner, such that cuts down the volume as well as the install space of the linear actuator, furthermore, isolating the axis force of the actuator completely from the transmission means, so as to enable the transmission means of the actuator to transmit torques in an effective and smooth way.

The primary object of the present invention is to provide a linear actuator, which is designed as having sleeve structure for accommodation of the main parts so as to cut down the install space as well as volume of the linear actuator, meanwhile, enables the transmission means of the actuator to transmit torques in an effective and smooth way.

The secondary object of the present invention is to provide a linear actuator that is capable of substantially bringing down the vibration and the noise of it, meanwhile, increasing the working efficiency in assembly.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is an exploded view of a linear actuator in accordance with the present invention;

FIG. 2 is a partial assembly illustrative view of FIG. 1;

FIG. 3 is a cross sectional view of FIG. 2.

### DETAILED DESCRIPTION OF THE PREFERRED EMBODIMENT

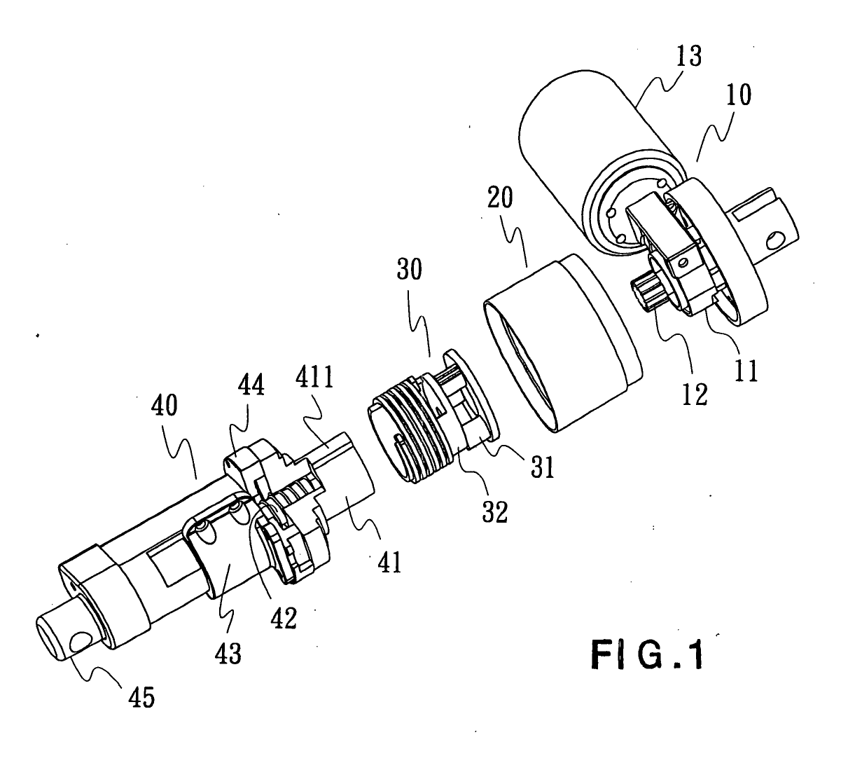

Referring to FIG. 1, which shows an exploded view of a linear actuator of the present invention, wherein the linear actuator generally comprises: a power set 10, a sleeve 20, a transmission means 30 and an actuator 40. The power set 10 generally including a worm gear set 11, a small gear 12 and a motor 13. When the motor 13 drives the worm gear set 11 for carrying out the first stage reduction, the small gear 12 of the worm gear set 11 will rotate along with the worm gear set 11. At the same time, the small gear 12 of the power set 10 engages with planetary gear 31 of the transmission means 30 in the sleeve 20, such that the small gear 12 drives the planetary gear 31 of the transmission means 30 to perform the second stage reduction (this transmission means can equally disperse the torque such that the torque transmission can be performed in a most effective way of outputting greatest torque with smallest volume). The planetary gear 31 is connected with the transmission portion 32 so as to drive the transmission portion 32 at a reduced rotation speed. Furthermore, the transmission portion 32 of the transmission means 30 is connected with a coupling portion 41 of the actuator 40 in the sleeve 20 in a coaxial manner, that is to say, at the transmission portion 32 is provided with grooves for matching with plural oblong keys 411 on the coupling portion 41 so as to enable the coupling portion 41 to rotate along with the transmission portion 32. A spindle 42 of the actuator 40 connects to the coupling portion 41 and rotates along with the same. A threaded nut 43 is disposed on the spindle 42 for turning rotating motion into linear reciprocated motion, such that the output shaft 45 connecting to the threaded nut 43 is allowed to axially reciprocate and drive the objects to move.

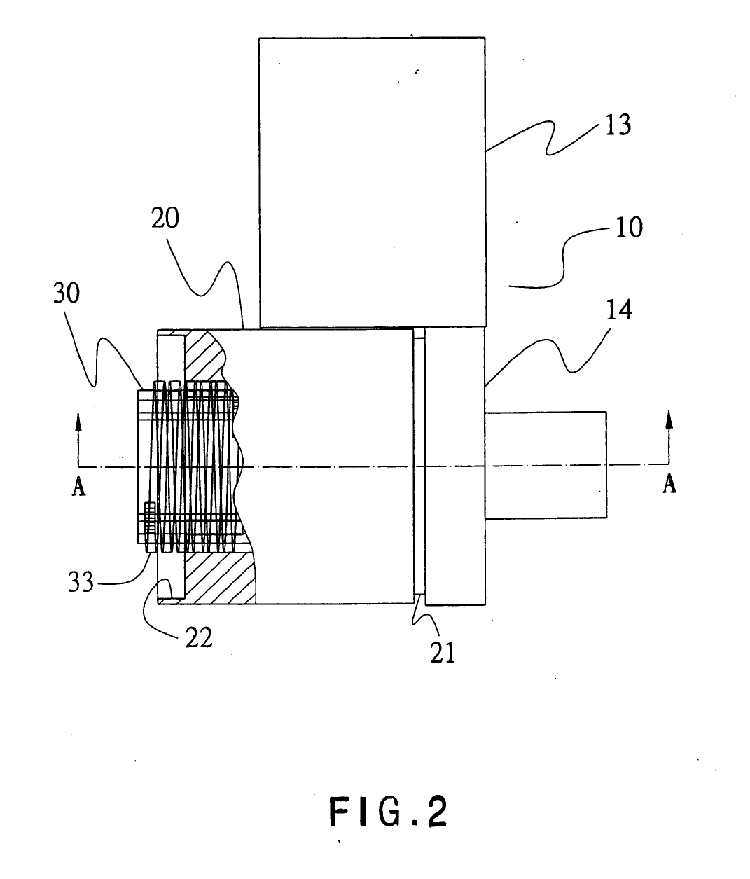

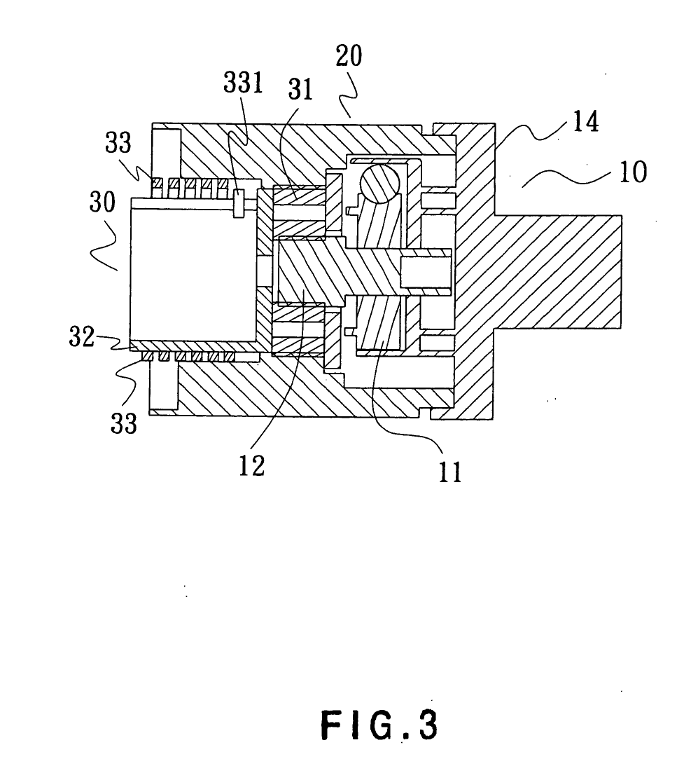

Referring further to FIGS. 2-3, wherein the power set 10 is provided with a cap 14 which can be axially coupled to an engaging portion 21 at the rear end of the sleeve 20, while the engaging portion 22 at the front end of the sleeve 20 is axially coupled with the coupling portion 44 of the actuator 40 (as shown in FIG. 1), such that the axis force will be shared by the front and rear end of the sleeve 20, and no axis force will effect on the transmission means 30 in the sleeve 20. Thereby the transmission means 30 is capable of transmitting the power from the power set 10 to the coupling portion 41 of the actuator 40 in an effective and smooth way and synchronously driving the spindle 42 and the threaded nut 43 for effecting the reciprocation of the output shaft 45, in this case, the linear actuator of the preset invention is capable of relatively improving the torque-outputting efficiency of the motor 13. On the other hand, the transmission means 30 is provided at the outer surface of the transmission portion 32 thereof with a torque spring 33 which has an inward chamfer 331 defined at both ends respectively for engaging with the transmission portion 32. By such arrangements, when the transmission portion 32 of the transmission means 30 is driven to rotate, which will cause a synchronous rotation of the torque spring 33. However, in case that the actuator of the present invention has an inward load while the motor 13 doesn't have outputting torque, the threaded nut 43 will turn the inward axial force of the load into rotating movement of the spindle 42, which will then give rise to axial expansion of the torque spring 33 after chamfers 331 at the front end of the same are driven by the oblong keys 411 of the actuator 40. The axial expansion accordingly brings about frictions of the outer periphery of the torque spring 33 against the internal surface of the sleeve 20, so as to achieve a function of self-brake. At this moment, if the motor 13 starts to reverse rotate in order to withdraw the output shaft 45, the power is transmitted to the transmission portion 32 of the transmission means 30 from the power set 10 so as to drive the chamfer 331 at the rear end of the torque spring 33 and make the axially expanded spring return to normal, thus to rotate and unlock the same, meanwhile driving the spindle 42 for withdrawing the object.

The advantages of the present invention lie in:

First, the linear actuator of the present invention is designed as having a sleeve for receipt of the respective parts, in which, the respective parts are connected in a coaxial way, whereby to relatively cut down volume of the linear actuator as well as its install space.

Second, the parts of the linear actuator of the present invention are coaxially connected in the sleeve, such that the axis force of the actuator can be blocked outside the sleeve so as to enable the transmission means to transmit torques smoothly and effectively.

Third, the parts of the linear actuator in accordance with the present invention are mainly circular designed to make so as to facilitate the processing, and the round-shape parts may be coupled in a coaxial manner, such that substantially brings down the vibration as well as the noise, and meanwhile increases the assembling efficiency. On the other hand, the transmission means of the present invention is capable of equally dispersing the torque such that the torque transmission can be performed in a most effective way of outputting greatest torque with smallest volume.

While we have shown and described various embodiments in accordance with the present invention, it should be clear to those skilled in the art that further embodiments may be made without departing from the scope of the present invention.

1. A linear actuator at least comprising:
a power set having a motor for outputting torque and further having a first stage reduction device;
an actuator having a spindle and threaded nut for enabling an output shaft coupled with the threaded nut to axially reciprocate, whereby to effect movement of the objects to be operated;
a transmission means for second stage of decelerating the output of the power set and then transmitting the torque to the actuator;
a sleeve axially coupling to the power set as well as the actuator, the power set, the transmission means and the actuator being coupled together in the sleeve, whereby to cut down the volume of the linear actuator as well as its install space, meanwhile, the sleeve bearing the axis force so as to enable the transmission means to transmit torques smoothly and effectively.

2. The linear actuator as claimed in claim 1, wherein the power set is provided with a cap for axially coupling to the sleeve.

3. The linear actuator as claimed in claim 1, wherein the actuator has a coupling portion for coupling with an engaging portion of the sleeve.

4. The linear actuator as claimed in claim 1, wherein the transmission means is coupled with the actuator in the sleeve in a coaxial way so as to transmit torque.

5. The linear actuator as claimed in claim 1, wherein the transmission means has a transmission portion in form of hollow slot, at the outer surface of the transmission portion is provided with a torque spring having an inward chamfer defined at the front and rear ends respectively for engaging with transmission portion.

6. The linear actuator as claimed in claim 1, wherein the power set is coupled with the transmission means in the sleeve by virtue of planetary gear structure, such that not only carry out the second stage reduction but also make it possible to equally disperse the torque so as to enable the torque transmission to be performed in a most effective way of outputting greatest torque with smallest volume.

7. The linear actuator as claimed in any one of the claim 1 to 6, wherein the parts of the linear actuator in accordance with the present invention are mainly round-shape designed so as to facilitate the processing, and the round-shape parts may be coupled in a coaxial manner, such that substantially brings down the vibration as well as the noise, and meanwhile increases the assembling efficiency.
